(19) United States
(12) Patent Application Publication
(10) Pub. No.: US 2026/0072753 A1
(43) Pub. Date: Mar. 12, 2026

(54) SYSTEM AND METHOD FOR COST-AWARE AUTOSCALING OF ARTIFICIAL INTELLIGENCE WORKLOADS USING PREDICTIVE QUEUING MODELS

(71) Applicants: Mahamood Hussain MIRZA, Londonderry, NH (US); Divyaraj Singh JATAV, Woburn, MA (US); Harshal SHAH, Milpitas, CA (US); Rajit NAIR, Sehore (IN)

(72) Inventors: Mahamood Hussain MIRZA, Londonderry, NH (US); Divyaraj Singh JATAV, Woburn, MA (US); Harshal SHAH, Milpitas, CA (US); Rajit NAIR, Sehore (IN)

(21) Appl. No.: 19/388,881

(22) Filed: Nov. 13, 2025

(51) Int. Cl. G06F 9/50; H04L 9/40

(52) U.S. Cl. CPC G06F 9/505; H04L 63/0428

(57) ABSTRACT

The present invention relates to a system and computer implemented method for cost-aware autoscaling of artificial intelligence workloads using predictive queueing models, designed to achieve proactive and economically optimized scaling of computational resources across cloud and edge environments. The invention introduces a predictive queueing-based technique that anticipates future workload congestion by modeling dynamic task arrivals and service times using a stochastic queueing process. A cost estimation unit computes the total projected operational cost of potential scaling actions by integrating real-time infrastructure pricing data, predicted delay penalties derived from service-level objectives, and estimated energy consumption. A scaling decision unit applies reinforcement learning-based optimization to select the scaling action that minimizes total cost while ensuring compliance with latency and throughput constraints. The system includes a hardware-integrated autoscaling controller device comprising a predictive computation processor, cost-decision processor, and scaling actuation interface configured for real-time execution of predictive and scaling operations.

### TECHNICAL FIELD

The present invention relates to artificial intelligence (AI) workload management in distributed computing environments, and more particularly, to a system and method for adaptive autoscaling of AI training or inference workloads using predictive queueing models that optimize the trade-off between computational cost and latency. The invention further pertains to a hardware-integrated autoscaling controller machine designed to implement cost-aware queue prediction, resource allocation, and scaling actions in real time within cloud or edge infrastructures.

### BACKGROUND OF THE INVENTION

With the growing adoption of AI workloads in cloud and edge data centers, dynamic scaling of compute resources such as virtual machines, GPUs, or containerized instances has become essential for maintaining performance under fluctuating demand. Conventional autoscaling mechanisms are largely reactive, relying on threshold-based triggers (e.g., CPU utilization, queue length, or memory load) to scale resources up or down. Such reactive systems fail to anticipate upcoming workload spikes, resulting in performance degradation or underutilized resources.

Moreover, existing autoscaling systems often neglect the cost implications associated with scaling decisions. In large-scale AI deployments, where multiple models or inference pipelines run concurrently, aggressive scaling may reduce latency but substantially increase operational expenditure. Conversely, overly conservative scaling may reduce costs but lead to prolonged queue times, violating service-level objectives (SLOs).

There is thus a need for a predictive, cost-aware autoscaling system capable of modeling future queue dynamics, forecasting workload arrival rates, and proactively allocating computational resources based on predicted service delays and associated cost penalties. The invention described herein addresses these limitations by introducing a hybrid predictive queueing framework coupled with a reinforcement learning-based cost optimizer, capable of delivering adaptive scaling decisions that balance performance and expenditure.

In modern cloud and edge computing infrastructures, autoscaling has emerged as a fundamental mechanism to maintain operational efficiency and service-level compliance under fluctuating computational demand. The underlying premise of autoscaling lies in dynamically allocating computing resources-such as CPUs, GPUs, or containerized instances-based on workload variations in order to meet performance objectives without incurring unnecessary costs. However, as the scale and complexity of AI workloads have increased, traditional autoscaling approaches have become insufficient. AI applications, particularly deep learning-based inference and training tasks, exhibit highly variable computational patterns, data dependencies, and latency sensitivities. This inherent unpredictability challenges the conventional threshold-based scaling mechanisms widely employed in industry.

Existing autoscaling systems, such as those implemented in cloud orchestration frameworks like Amazon EC2 Auto Scaling, Google Cloud Autoscaler, or Kubernetes Horizontal Pod Autoscaler (HPA), operate predominantly in a reactive manner. These systems monitor specific resource utilization metrics—such as CPU load, memory consumption, or average queue length—and initiate scaling actions once a threshold is breached. While these systems can respond effectively to gradual increases in load, they fail to anticipate rapid workload spikes that characterize AI-based services, such as real-time image recognition, speech processing, or recommendation systems. The fundamental drawback of such reactive scaling is latency; the time lag between detecting high utilization and provisioning additional resources often leads to performance degradation, task queuing, and service-level objective violations. Furthermore, in distributed AI pipelines where multiple models or microservices interact, the propagation of delays through the system amplifies the performance bottlenecks.

Another major limitation of existing solutions is their disregard for economic cost modeling. Cloud resources are typically billed per usage unit (for example, per hour for virtual machines or per request for serverless functions), and aggressive scaling can significantly inflate operational expenditure. Conversely, conservative scaling to save cost may lead to service slowdowns or unprocessed task backlogs. This creates a complex optimization problem involving trade-offs between computational cost, response latency, and throughput. Current commercial autoscaling systems do not offer a native mechanism for evaluating or optimizing this trade-off in real time.

Instead, they rely on static user-defined rules or target utilization percentages that do not adapt to contextual changes in demand patterns, cloud pricing variations, or AI workload structures.

Existing research also demonstrates limitations in integrating autoscaling decisions with predictive workload scheduling. While predictive autoscaling may provision additional nodes in anticipation of load spikes, it often lacks integration with scheduling techniques that determine which workload to prioritize or where to deploy it. This disconnection results in suboptimal resource placement and queuing delays even when sufficient capacity is available. Furthermore, predictive scaling models rarely incorporate uncertainty quantification, leading to overconfident predictions that may trigger unnecessary scaling. Techniques like Bayesian neural networks or probabilistic forecasting, which could provide uncertainty estimates, remain largely unexplored in this context due to their computational complexity.

Another dimension of the problem lies in cost-aware autoscaling within multi-tenant and federated environments. In modern AI ecosystems, multiple tenants or services may share underlying infrastructure, each with distinct latency requirements and budget constraints. Traditional autoscalers treat all workloads uniformly, ignoring tenant-level differentiation. This results in unfair resource allocation, where cost-sensitive workloads may experience degradation due to high-priority AI tasks consuming shared capacity. Although service mesh architectures have attempted to introduce quality-of-service (QoS) differentiation, they do not provide predictive cost modeling or joint optimization of cost and latency across tenants. As a result, organizations face difficulty in maintaining predictable cost behavior while ensuring adequate service quality for AI workloads.

Furthermore, the energy consumption associated with large-scale AI workloads adds another dimension to the cost problem. Many existing autoscalers optimize only for performance metrics without considering the energy implications of scaling decisions. Over-provisioning of resources, especially GPU clusters, leads to unnecessary power draw and environmental impact. With growing emphasis on sustainable computing, energy-aware scaling policies are becoming essential. However, integrating energy efficiency with predictive scaling remains an open challenge, as most energy models are workload-agnostic and fail to capture the unique computational behavior of AI models with varying batch sizes, tensor operations, and hardware acceleration characteristics.

Another critical shortcoming in current autoscaling architectures is the latency associated with scaling itself. The time required to provision a new virtual machine, start a container, or attach a GPU can range from several seconds to minutes, depending on the cloud provider. During this provisioning delay, incoming AI inference requests accumulate in queues, leading to temporary service degradation. Reactive autoscalers that rely solely on metric thresholds often initiate scaling too late to mitigate this delay. Proactive systems based on workload prediction can partially alleviate the issue, but inaccurate predictions can exacerbate instability. An ideal autoscaling system would not only predict workload trends but also estimate the queueing delay during scaling transitions, thereby scheduling scaling actions with foresight.

Cloud-native AI workloads further complicate the scaling process because they involve multiple interdependent microservices. For example, a typical AI pipeline may consist of a data ingestion service, preprocessing service, model inference service, and result aggregation service. Scaling any one of these components in isolation can lead to downstream bottlenecks if the others are not scaled proportionally. Existing autoscaling systems largely treat microservices independently, with scaling decisions based on local metrics rather than end-to-end performance. This leads to mismatched scaling states across the pipeline, inefficient resource usage, and compounded queuing delays. An effective solution would need to coordinate scaling decisions across the entire pipeline using a global optimization framework that accounts for inter-service dependencies, latency propagation, and cumulative cost.

Moreover, in distributed AI deployments extending to edge environments, traditional cloud-based autoscalers face difficulties due to network variability, limited resource capacity, and intermittent connectivity. Edge nodes often operate under strict latency budgets, and their scaling options may be constrained to a small pool of local devices. Centralized autoscaling controllers located in the cloud are unsuitable in such scenarios due to high communication latency and limited contextual awareness. Edge-native predictive autoscaling requires localized decision-making with minimal dependency on centralized orchestration. However, current solutions lack dedicated hardware or embedded control systems capable of executing such predictive scaling decisions autonomously in real time.

The existing autoscaling landscape suffers from several intertwined challenges-reactive behavior, absence of predictive queueing models, lack of cost awareness, limited coordination among distributed services, and inadequate integration of energy and latency constraints. While modern machine learning-based and reinforcement learning-based approaches have shown promise, they remain computationally heavy, context-insensitive, and economically naïve. There is therefore a pressing need for a unified system that combines predictive queueing models with cost optimization frameworks and can operate both in cloud and edge contexts through a dedicated hardware-integrated controller device. Such a system would represent a substantial advancement over existing autoscaling methods by enabling proactive, cost-sensitive, and performance-consistent scaling for AI workloads operating in heterogeneous distributed environments.

### SUMMARY OF THE INVENTION

The invention provides a system and method for cost-aware autoscaling of AI workloads using predictive queueing models. The system employs a hybrid predictive engine that combines Markov-modulated Poisson process (MMPP)-based workload estimation with deep neural network (DNN)-driven service time prediction. These predictions are fed into a dynamic queueing model that anticipates future task waiting times and determines optimal scaling actions under budget constraints.

A cost optimization controller computes the marginal cost-benefit of scaling decisions by integrating both cloud instance pricing models and latency-based penalties. Scaling actions are executed through a hardware-integrated autoscaling controller device, which includes a resource interface, prediction accelerator circuitry, and a decision logic core embedded in a programmable hardware structure such as an FPGA or ASIC.

The system operates in both training and inference contexts, supporting GPU/TPU clusters, container orchestration environments (e.g., Kubernetes), and hybrid edge-cloud topologies. The method minimizes cost while maintaining SLO compliance by continuously learning workload patterns and dynamically adapting the resource configuration.

The principal object of the present invention is to provide a system and method for cost-aware autoscaling of AI workloads using predictive queueing models that overcomes the deficiencies of existing reactive and threshold-based autoscaling approaches. The invention aims to introduce a predictive and cost-optimized scaling framework capable of anticipating workload fluctuations, estimating queueing delays, and determining scaling actions that balance performance objectives with operational cost efficiency. Unlike traditional methods that rely on static utilization thresholds or historical averages, the present invention employs a dynamic queueing-based prediction model combined with reinforcement learning-based cost optimization, enabling proactive scaling decisions that align computational resource usage with real-time demand variations and budgetary constraints.

Another object of the invention is to integrate queueing theory with AI-driven workload forecasting to model the stochastic nature of task arrivals and service times in AI pipelines. By employing Markov-modulated Poisson processes or other stochastic queueing representations in conjunction with neural prediction models for service time estimation, the system can accurately predict future queue lengths and waiting times. This predictive capability allows the invention to anticipate system congestion before it occurs and initiate timely scaling actions that prevent performance degradation without over-provisioning.

A further object of the invention is to incorporate cost-awareness as a first-class decision parameter in autoscaling, thereby enabling the system to evaluate the financial impact of scaling actions in real time. The system introduces a dynamic cost model that considers both infrastructure pricing and delay penalties to compute the expected total cost of each scaling decision. Through reinforcement learning or similar optimization mechanisms, the system continuously refines its scaling policy to achieve minimal total cost while satisfying latency and throughput constraints. This ensures that organizations operating large-scale AI workloads can maintain predictable expenditure patterns without compromising service-level objectives.

It is also an object of the invention to provide a unified scaling framework that functions seamlessly across heterogeneous environments, including cloud, hybrid, and edge infrastructures. The proposed invention supports scaling across different resource types such as CPUs, GPUs, TPUs, and container instances, integrating with orchestration systems like Kubernetes or Docker.

Through predictive queueing coordination, the system ensures synchronized scaling across multiple interdependent AI microservices, preventing bottlenecks caused by unsynchronized scaling of upstream and downstream components. This cross-layer integration ensures end-to-end optimization of the AI workload pipeline, improving both resource efficiency and response time consistency.

Another object of the invention is to reduce scaling latency by integrating predictive computation into a hardware-assisted controller device that can perform real-time inference of workload trends and queueing states. The hardware device, implemented as a Predictive Autoscaling Controller Unit (PACU), hosts embedded processors, tensor accelerators, and decision logic circuits capable of executing predictive queueing computations locally, without dependence on external orchestration delays. This physical embodiment allows for near-instantaneous execution of scaling decisions, making it particularly effective for latency-critical AI applications deployed in edge or 5G environments where centralized scaling control is impractical.

It is a further object of the invention to enhance energy efficiency and sustainability in AI workload management by coupling the predictive scaling mechanism with power consumption models. By correlating scaling actions with their expected energy costs, the system can favor resource allocation strategies that minimize overall power draw without violating performance thresholds. This capability enables data centers and edge nodes to adopt environmentally conscious scaling policies, reducing carbon footprint while maintaining computational reliability.

A further object of the invention is to minimize computational and operational overhead associated with traditional autoscaling frameworks by offloading predictive analytics and decision logic to dedicated hardware and optimized firmware routines. This offloading ensures that the main workload infrastructure remains focused on AI task execution rather than control computation, thereby improving overall system throughput and reducing scaling decision latency.

It is another object of the invention to create a generalizable autoscaling framework applicable across diverse AI workload types, including batch processing, streaming inference, reinforcement learning training, and multimodal model serving. The predictive queueing model and cost optimization logic are designed to be agnostic to the specific AI architecture, allowing broad applicability across different deployment contexts. This universality ensures that the system can be adopted widely across industries such as healthcare, autonomous systems, finance, and telecommunications, wherever AI-driven computational demand exhibits temporal variability.

Finally, an overarching object of the invention is to enable proactive, cost-efficient, and self-optimizing autoscaling behavior that can operate continuously without manual intervention. Through its combination of predictive queueing analytics, reinforcement learning-based cost evaluation, and hardware-level control execution, the invention achieves a level of autonomy and foresight that surpasses existing scaling solutions. The invention not only reacts to workload changes but anticipates them, applying intelligent, cost-sensitive strategies that enhance both economic and operational performance in AI-driven computational environments.

Through these and other objectives, the invention provides a transformative advancement in the field of intelligent resource management, introducing a predictive, cost-aware, and hardware-accelerated autoscaling paradigm capable of addressing the pressing challenges of performance variability, cost unpredictability, and system instability that plague current AI workload management systems.

### BRIEF DESCRIPTION OF FIGURES

These and other features, aspects, and advantages of the present invention will become better understood when the following detailed description is read concerning the accompanying drawings in which like characters represent like parts throughout the drawings, wherein:

FIG. 1 displays a block diagram of a system for cost-aware autoscaling of artificial intelligence workloads using predictive queuing models;

FIG. 2 displays flow chart of a method for cost-aware autoscaling of artificial intelligence workloads using predictive queuing models;

FIG. 3 illustrates a table depicting a comparative analysis between reactive autoscaling and the claimed predictive cost-aware autoscaling system under increasing workload intensity;

FIG. 4 illustrates a line chart showing the comparative latency response of reactive versus predictive autoscaling mechanisms;

FIG. 5 illustrates a table depicting the total operational cost incurred over time under reactive and predictive cost-aware autoscaling conditions;

FIG. 6 illustrates a bar chart showing comparative energy consumption across central, graphical, and tensor processing units during workload scaling;

FIG. 7 illustrates a pie chart showing the distribution of scaling actions performed by the predictive cost-aware autoscaling system; and

FIG. 8 illustrates a line chart showing service-level objective (SLO) compliance over time under reactive and predictive autoscaling conditions.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

The functional units described in this specification have been labeled as devices. A device may be implemented in programmable hardware devices such as processors, digital signal processors, central processing units, field programmable gate arrays, programmable array logic, programmable logic devices, cloud processing systems, or the like. The devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together, but may comprise disparate instructions stored in different locations which, when joined logically together, comprise the device and achieve the stated purpose of the device.

Indeed, an executable code of a device or module could be a single instruction, or many instructions, and may even be distributed over several different code segments, among different applications, and across several memory devices. Similarly, operational data may be identified and illustrated herein within the device, and may be embodied in any suitable form and organized within any suitable type of data structure. The operational data may be collected as a single data set, or may be distributed over different locations including over different storage devices, and may exist, at least partially, as electronic signals on a system or network.

In accordance with the exemplary embodiments, the disclosed computer programs or modules can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Some of the disclosed embodiments include or otherwise involve data transfer over a network, such as communicating various inputs or files over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. The network may include multiple networks or sub networks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VOIP, Voice-over-ATM, or other comparable protocols used for voice data communications. In one implementation, the network includes a cellular telephone network configured to enable exchange of text or SMS messages.

Examples of the network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

Embodiments of the present disclosure will be described below in detail with reference to the accompanying drawings.

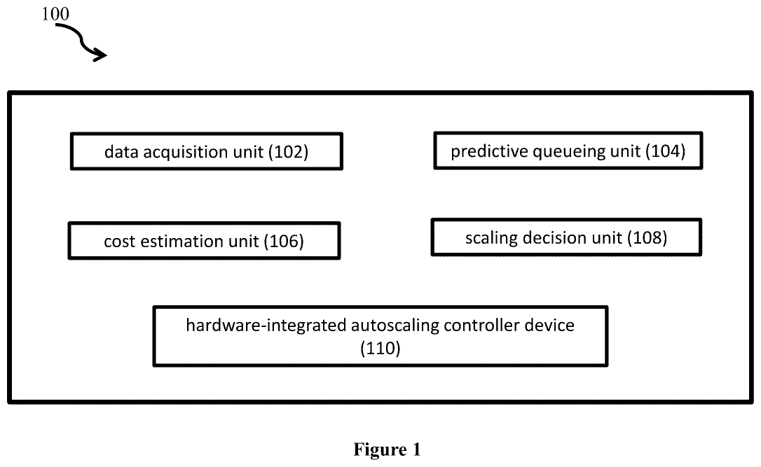

Referring to FIG. 1, a block diagram of a system for cost-aware autoscaling of artificial intelligence workloads using predictive queuing models is illustrated. The system 100 is comprises: a data acquisition unit (102) configured to receive and process a plurality of workload parameters including task arrival rate, service time statistics, resource utilization metrics, and queue length values from a plurality of distributed computational nodes executing artificial intelligence workloads; a predictive queueing unit (104) communicatively coupled to the data acquisition unit, the predictive queueing unit configured to determine, in real time, future queueing states of the workloads by modeling arrival patterns through a stochastic queueing process and by determining an estimated service time for each task based on historical execution data and current resource states; a cost estimation unit (106) configured to compute a total projected operational cost associated with scaling decisions, the total projected operational cost including a resource allocation cost derived from cloud resource pricing information and a delay cost computed from a service-level objective violation penalty associated with predicted queueing delay; a scaling decision unit (108) coupled to the predictive queueing unit and the cost estimation unit, the scaling decision unit configured to evaluate a plurality of scaling options including scale-up, scale-down, and steady-state maintenance by comparing the total projected operational cost of each option and selecting an optimal scaling action that minimizes cost while maintaining latency and throughput constraints; and a hardware-integrated autoscaling controller device (110) comprising a predictive computation processor, a cost-decision processor, and a scaling actuation interface, wherein the autoscaling controller device executes the selected scaling action by controlling the instantiation or termination of computing resources in a distributed computing infrastructure.

In an embodiment, the predictive queueing unit (104) comprises a plurality of processors configured to execute a stochastic queueing model that dynamically estimates task arrival patterns using a Markov-modulated Poisson process, wherein the process transitions between a plurality of states corresponding to distinct workload intensities, and wherein each transition probability is continuously updated using real-time workload statistics acquired from the data acquisition unit.

In an embodiment, the predictive queueing unit (104) further comprises a neural network-based prediction processor configured to compute the expected service time of each workload by learning from historical task execution traces, hardware utilization logs, and prior scaling actions, such that the predicted service time adapts dynamically to variations in workload complexity and resource heterogeneity across central processing units, graphical processing units, and tensor processing units.

In an embodiment, the cost estimation unit (106) comprises a computational processor configured to determine the total projected operational cost by concurrently evaluating a plurality of cost functions, each representing a different scaling policy, and wherein the processor integrates instance pricing information, workload delay penalties, and energy consumption metrics to form a multidimensional cost surface from which a minimum-cost point corresponding to the optimal scaling configuration is extracted through iterative optimization.

In an embodiment, the scaling decision unit (108) comprises a decision processor configured to apply reinforcement learning-based optimization, wherein the decision processor maintains a policy table mapping predicted queueing states and cost metrics to scaling actions, and wherein the policy table is continuously updated based on observed performance feedback and resource utilization to minimize cumulative operational cost over time.

In an embodiment, the autoscaling controller device (110) further comprises: a telemetry interface circuit configured to continuously collect real-time workload telemetry data from distributed compute clusters; a predictive computation processor configured to execute queueing model computations and service time forecasts locally within a hardware circuit; a cost-decision processor configured to evaluate cost functions using dedicated arithmetic logic units; and a scaling actuation interface configured to transmit scaling control signals to orchestration systems through secure communication protocols for the addition or removal of virtual computing instances.

In an embodiment, the predictive computation processor comprises an embedded tensor arithmetic unit configured to execute predictive queueing computations in fixed-point arithmetic form to minimize computational latency, and wherein said tensor arithmetic unit operates under a low-power regime suitable for continuous operation in edge data center environments.

In an embodiment, the scaling actuation interface is configured to interface with a plurality of orchestration systems selected from the group consisting of Kubernetes, Docker Swarm, and OpenStack, and wherein the scaling actuation interface translates internal scaling decisions into orchestration-specific commands for initiating, scheduling, or terminating computational resources.

In an embodiment, the data acquisition unit (102) is configured to normalize and time-synchronize incoming workload telemetry data from multiple nodes, and wherein the data acquisition unit further comprises a synchronization processor that performs temporal alignment of task metrics using clock-offset compensation to ensure consistency of queueing state estimation across geographically distributed computing environments.

In an embodiment, the predictive queueing unit (104), the cost estimation unit, and the scaling decision unit collectively form a closed feedback control loop implemented in firmware on the autoscaling controller device, such that each scaling action generates a subsequent feedback signal containing updated latency, throughput, and cost performance data, thereby enabling adaptive refinement of the predictive and decision models through iterative self-learning.

The system for cost-aware autoscaling of artificial intelligence workloads using predictive queueing models is implemented through a networked computing architecture comprising interoperable electronic and software-driven components that collectively perform telemetry collection, predictive modeling, cost computation, and actuation control in real time. The data acquisition unit is implemented as a processor-controlled interface circuit configured with a plurality of network input ports, buffer registers, and data normalization logic stored in memory; it continuously receives workload telemetry including task arrival rates, queue lengths, and utilization statistics from distributed computational nodes and performs preliminary operations such as timestamp parsing, noise filtration, and clock-offset correction before streaming normalized telemetry frames to the predictive queueing unit. The predictive queueing unit is enabled through dedicated computational resources executing stored instruction sequences that model queue dynamics using probabilistic equations and iterative estimation routines; the unit retrieves normalized input vectors from shared memory, applies stochastic prediction algorithms to determine expected waiting times and service durations for active and pending tasks, and generates predictive queue state descriptors for each computational node. The cost estimation unit comprises programmable logic circuitry and a processor executing stored arithmetic operations that integrate the predicted queueing delays, real-time infrastructure pricing data, and energy consumption parameters to compute multi-component cost vectors; each cost vector is aggregated through an internal cost-weighting function that calculates a total projected operational cost associated with every feasible scaling option. The scaling decision unit is implemented as a logical control subsystem communicatively coupled to the predictive queueing and cost estimation units through a high-speed interconnect bus; the unit executes decision algorithms stored in non-transitory memory that evaluate cost-to-performance trade-offs, apply stability thresholds derived from prior cycles, and determine the optimal scaling action by solving an optimization function that minimizes projected operational cost while preserving latency and throughput bounds. The hardware-integrated autoscaling controller device comprises one or more computation processors configured to execute predictive and cost-decision tasks in parallel, an embedded memory array storing temporary operational states, and a scaling actuation interface electrically coupled to the orchestration layer of the distributed infrastructure; the controller serializes the selected scaling command into protocol-compliant control messages, transmits them over secure control channels, and monitors acknowledgment signals indicating completion of resource instantiation or de-provisioning. Interconnection among all components is established through a shared data bus and synchronization clock enabling concurrent operation without race conditions, while all computation sequences are realized through stored program instructions executed by the processors to ensure deterministic implementation of the predictive queueing analysis, cost evaluation, decision selection, and actuation procedures defined by the computer-implemented method.

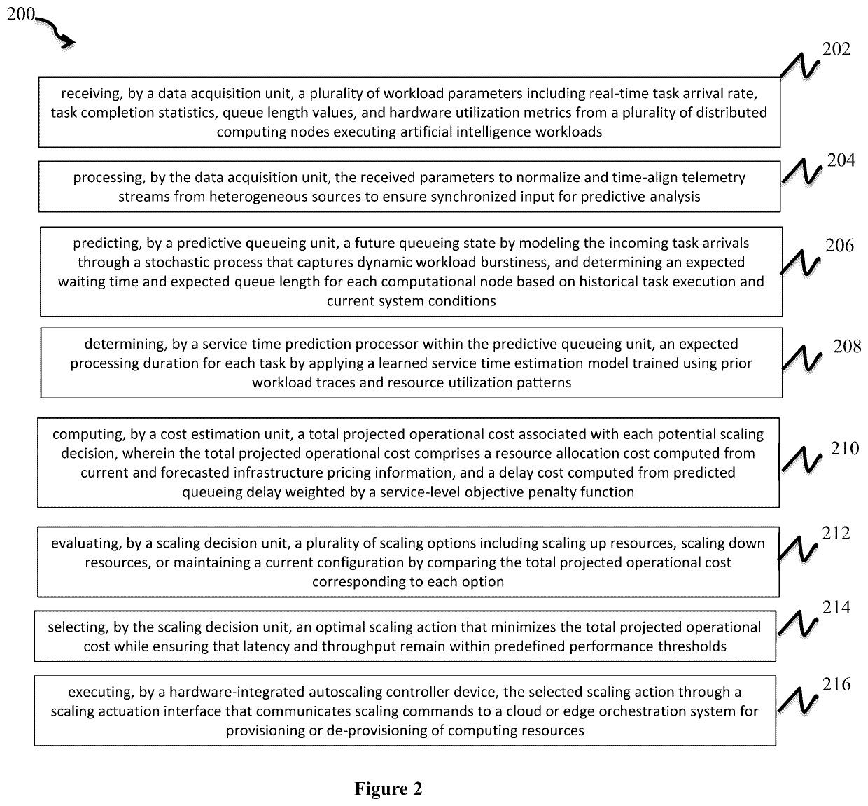

Referring to FIG. 2, a flow chart for a computer implemented method for cost-aware autoscaling of artificial intelligence workloads using predictive queueing models, the method comprising the steps of is illustrated. The method 200 comprises:
At step 202, the method 200 includes receiving, by a data acquisition unit, a plurality of workload parameters including real-time task arrival rate, task completion statistics, queue length values, and hardware utilization metrics from a plurality of distributed computing nodes executing artificial intelligence workloads;
At step 204, the method 200 includes processing, by the data acquisition unit, the received parameters to normalize and time-align telemetry streams from heterogeneous sources to ensure synchronized input for predictive analysis;
At step 206, the method 200 includes predicting, by a predictive queueing unit, a future queueing state by modeling the incoming task arrivals through a stochastic process that captures dynamic workload burstiness, and determining an expected waiting time and expected queue length for each computational node based on historical task execution and current system conditions;
At step 208, the method 200 includes determining, by a service time prediction processor within the predictive queueing unit, an expected processing duration for each task by applying a learned service time estimation model trained using prior workload traces and resource utilization patterns;
At step 210, the method 200 includes computing, by a cost estimation unit, a total projected operational cost associated with each potential scaling decision, wherein the total projected operational cost comprises a resource allocation cost computed from current and forecasted infrastructure pricing information, and a delay cost computed from predicted queueing delay weighted by a service-level objective penalty function;
At step 212, the method 200 includes evaluating, by a scaling decision unit, a plurality of scaling options including scaling up resources, scaling down resources, or maintaining a current configuration by comparing the total projected operational cost corresponding to each option;
At step 214, the method 200 includes selecting, by the scaling decision unit, an optimal scaling action that minimizes the total projected operational cost while ensuring that latency and throughput remain within predefined performance thresholds; and
At step 216, the method 200 includes executing, by a hardware-integrated autoscaling controller device, the selected scaling action through a scaling actuation interface that communicates scaling commands to a cloud or edge orchestration system for provisioning or de-provisioning of computing resources.

In an embodiment, the step of predicting the future queueing state comprises continuously estimating the arrival rate of tasks using a Markov-modulated Poisson process, wherein the process transitions among multiple arrival intensity states based on real-time telemetry, and wherein each transition probability is adaptively updated using a likelihood estimation computed from recent arrival statistics to reflect non-stationary workload dynamics.

In an embodiment, the step of determining the expected processing duration comprises computing, by a neural prediction model, the service time for each task as a function of workload type, current hardware configuration, and recent interference patterns across computational nodes, wherein said neural prediction model is trained using historical workload datasets annotated with completion time metrics and resource consumption logs.

In an embodiment, the step of computing the total projected operational cost further comprises computing a plurality of cost terms including an infrastructure usage cost determined from instance pricing models, a latency penalty cost derived from deviation from latency thresholds, and an energy cost computed from power consumption data of active resources, and summing the plurality of cost terms into an aggregate cost metric for each scaling option.

In an embodiment, the step of evaluating the plurality of scaling options comprises applying a reinforcement learning-based optimization process, wherein the scaling decision unit computes a policy function mapping predicted queueing states and cost estimations to scaling actions, and wherein the policy function is updated through temporal difference learning based on feedback from executed scaling outcomes to minimize cumulative operational cost.

In an embodiment, the step of executing the selected scaling action further comprises generating a scaling command signal formatted according to the orchestration protocol of a target infrastructure, transmitting said command through a secure communication interface, and verifying acknowledgment from the orchestration layer to confirm completion of resource instantiation or termination.

In an embodiment, the step of receiving workload parameters further comprises obtaining, by the data acquisition unit, telemetry data from a plurality of geographically distributed nodes operating under heterogeneous latency domains, and performing time synchronization using clock-offset estimation to maintain temporal alignment across the collected metrics.

In an embodiment, the step of selecting the optimal scaling action comprises simulating, by the scaling decision unit, multiple hypothetical future workload states over a prediction horizon, evaluating potential scaling trajectories for each simulated state using the predictive queueing model, and selecting a scaling trajectory that minimizes the expected operational cost across the prediction horizon.

In an embodiment, the hardware-integrated autoscaling controller device comprises a predictive computation processor configured to perform queue prediction computations using fixed-point arithmetic to reduce latency, a cost-decision processor configured to execute cost evaluations in parallel using arithmetic logic circuits, and a scaling actuation interface configured to dispatch control signals to resource orchestration endpoints.

In an embodiment, the predictive queueing unit further comprises an uncertainty quantification processor configured to determine a confidence level associated with each predicted queueing delay, and wherein the scaling decision unit adjusts the aggressiveness of the scaling action proportionally to the uncertainty value, thereby preventing unnecessary over-scaling when the prediction confidence is low.

In an embodiment, the step of processing the received workload parameters to normalize and time-align telemetry streams from heterogeneous sources comprises continuously receiving asynchronous telemetry updates through independent communication channels, buffering each incoming telemetry record in a circular memory buffer indexed by reception timestamp, estimating latency skew for each node by computing a time-difference distribution of successive samples, and performing dynamic alignment by adjusting each incoming record using an offset correction value obtained from a convergence iteration of a Kalman-based clock offset estimator, wherein each corrected data point is resampled through cubic spline interpolation to achieve uniform temporal resolution, and wherein the resulting synchronized telemetry dataset is segmented into discrete, non-overlapping analysis windows that serve as consistent input to the subsequent predictive modeling stage.

In one implementation, the received workload parameters originating from multiple heterogeneous system nodes—such as compute instances, network switches, and storage controllers—are processed in a manner that ensures both temporal uniformity and synchronization accuracy before being used for predictive analysis. Since these telemetry streams arrive asynchronously due to independent clock domains and network transmission delays, each incoming record is first routed through a dedicated communication channel to a local processing interface that manages a circular memory buffer indexed by precise reception timestamps. This buffer architecture allows continuous overwriting of the oldest entries while retaining sufficient temporal context for latency estimation, ensuring low memory overhead even under high-frequency update conditions.

For each source node, the system computes the latency skew by constructing a time-difference distribution between successive samples, thereby quantifying clock drift or jitter characteristics. These latency estimations feed into a Kalman-based clock offset estimator, which iteratively refines the offset correction values through convergence iterations that minimize the residual error between predicted and observed timing deviations. This adaptive correction process continuously compensates for asynchronous data arrival, making it possible to realign telemetry from nodes operating under different hardware clocks or communication routes.

Once offset-corrected, each telemetry record is resampled through cubic spline interpolation to generate values at uniform temporal intervals, effectively smoothing discontinuities and filling temporal gaps in the dataset. This interpolation ensures that sensor data streams with different sampling rates-such as CPU utilization reported every 50 ms and network throughput sampled every 120 ms—are harmonized into a single, uniformly spaced temporal sequence. The uniformly aligned dataset is then segmented into non-overlapping analysis windows, each corresponding to a fixed time span, to provide consistent input units for subsequent machine learning or predictive modeling algorithms.

For example, consider a distributed cloud monitoring scenario where telemetry from ten servers arrives at irregular intervals because of variable network congestion. Without correction, analytical modules downstream would misinterpret transient delays as workload fluctuations, leading to poor predictive stability. However, by employing the described Kalman-based offset correction and spline resampling, all telemetry points are projected onto a synchronized timeline with sub-millisecond temporal error. This consistent dataset significantly improves the accuracy of subsequent predictive queueing or anomaly detection models, as it eliminates artificial variance induced by transmission jitter.

The described process thus establishes a robust, mathematically grounded synchronization pipeline that transforms heterogeneous, noisy, and time-skewed telemetry into coherent, temporally consistent datasets. The resulting improvement in temporal fidelity directly enhances the precision of workload forecasting and system scaling decisions, yielding more stable operational control and minimizing erroneous predictions caused by asynchronous data behavior.

In an embodiment, the predicting of the future queueing state further comprises executing a continuous stochastic simulation loop in which: a) a baseline arrival rate is initialized from the exponential moving average of the last N observed inter-arrival intervals; b) for each iteration within a rolling prediction horizon, a probabilistic perturbation term is generated using a Gaussian random variable whose variance is proportional to the instantaneous coefficient of variation of recent arrivals; c) the simulated queue length is incrementally updated using a recursive equation of the form L(t+Δt)=max(0, L(t)+λ(t)Δt−μ(t)Δt), where λ(t) is the perturbed arrival rate and μ(t) the predicted service rate; and d) convergence is declared when the absolute difference between the last two predicted queue length averages is less than a dynamically computed stability threshold obtained by evaluating the mean absolute deviation over the last k windows of actual telemetry. In the equation, L(t) denotes the instantaneous number of pending tasks in the queue at time t as derived from telemetry received by the data acquisition unit, L(t+Δt) represents the forecasted queue length at a future prediction interval t+Δt, constrained by a non-negativity condition through the max(0, . . . ) operator, λ(t) denotes the perturbed task arrival rate at time t computed through a Markov-modulated Poisson process in which each hidden state corresponds to a distinct workload intensity level,
μ(t) denotes the predicted service rate at time t computed as the inverse of the expected service duration determined by the learned service-time model, and Δt represents an adaptive time increment that is dynamically varied as an inverse function of the observed variance in recent task inter-arrival intervals to stabilize the predictive simulation resolution; wherein the recursive update is repeatedly evaluated over successive prediction windows until the absolute difference between successive queue length predictions falls below a predetermined convergence threshold, thereby yielding a stabilized forecast of future queue occupancy for subsequent cost and scaling evaluation.

In one implementation, prediction of the future queueing state is carried out through a continuous stochastic simulation framework that evolves over a rolling prediction horizon, enabling the system to dynamically forecast workload buildup and depletion under uncertain arrival and service rate conditions. The process begins with computation of a baseline arrival rate using an exponential moving average (EMA) derived from the most recent N observed inter-arrival intervals. The EMA formulation ensures that more recent data points exert a higher influence than older observations, allowing the system to remain responsive to sudden load changes while retaining longer-term stability. This baseline forms the deterministic foundation upon which stochastic fluctuations are modeled.

To reflect real-world uncertainty, each iteration introduces a probabilistic perturbation term, modeled as a Gaussian random variable. The variance of this random term is made proportional to the instantaneous coefficient of variation of the recent arrivals, ensuring that periods of high traffic irregularity lead to broader stochastic exploration, while stable conditions generate narrower deviations. This dynamically controlled randomness enables the simulation to capture real-world volatility in incoming workloads without resorting to over-generalized noise modeling.

At the heart of the simulation lies the recursive queue update equation, expressed as: [L(t+Δt)=\max(0, L(t)+λ(t)Δt−μ(t)Δt)] where (L(t)) denotes the current simulated queue length, (λ(t)) the perturbed arrival rate incorporating stochastic fluctuation, and (μ(t)) the predicted service rate derived from real-time telemetry of processing nodes. The use of the max(0, . . . ) operator ensures physical validity by preventing negative queue lengths. This recursive formulation emulates how queued requests accumulate and are serviced over infinitesimal time steps, providing a high-resolution temporal evolution of system load.

The simulation continues iteratively, recalculating queue length at every step, until convergence is detected. Convergence is determined when the absolute difference between successive predicted queue length averages falls below a stability threshold, which itself is dynamically computed as the mean absolute deviation (MAD) of actual telemetry-derived queue lengths observed in the last k windows. This adaptive threshold ensures that convergence is not defined by arbitrary fixed tolerances but by the intrinsic variability of the system's own recent behavior, allowing flexible, context-aware termination of the simulation loop.

In practical operation—such as within a cloud-based API gateway or an edge computing scheduler—this mechanism can accurately forecast imminent queue saturation events before they occur. For example, if telemetry indicates a sudden surge in incoming requests but service rates remain constant, the stochastic simulation anticipates when the queue length will exceed the nominal service capacity. By generating these predictions continuously, the system can trigger pre-emptive scaling operations, such as provisioning an additional processing node or increasing thread pool size, before latency degradation becomes observable.

This probabilistic forecasting loop thus enables resilient and anticipatory resource management by integrating real-time telemetry with mathematically grounded stochastic modeling. The combination of adaptive Gaussian perturbation, recursive load evolution, and convergence validation ensures that queue predictions remain both stable and responsive, providing a fine balance between computational efficiency and predictive precision under dynamic, uncertain workload conditions.

In an embodiment, the determining of the expected processing duration for each task comprises executing a resource-performance correlation computation that constructs, for each task type, a multidimensional dependency matrix representing the non-linear relation between execution duration, resource allocation ratio, and observed contention indices, wherein the matrix is updated incrementally after each completed task using stochastic gradient descent on the prediction residual, and wherein the service time for a new task is predicted by performing a weighted interpolation within the matrix along the axes corresponding to active CPU core allocation, memory bandwidth utilization, and I/O throughput saturation.

In one implementation, the system produces per-task expected processing durations by building and continuously refining a multidimensional dependency matrix that captures how observed execution time non-linearly depends on resource allocation and contention signals; for each discrete task type the matrix axes represent normalized resource allocation ratios (e.g., fraction of CPU cores assigned, normalized memory bandwidth usage, and normalized I/O throughput saturation) and auxiliary contention indices (such as thread-contention rate, cache-miss rate, and queueing delay percentiles) so that each cell implicitly encodes an empirical service-time distribution for that local operating point. Prediction for a new task consists of locating its coordinate on the normalized axes, performing the weighted interpolation to produce ŷ, and optionally applying a small uncertainty correction derived from local variance estimates drawn from neighboring cells. For example, when a compression job is scheduled with 0.4 CPU share, 0.7 memory bandwidth utilization, and 0.3 I/O saturation, the system interpolates the matrix cells surrounding that point to predict a service time and then refines the underlying parameters after the job completes. By encoding non-linear interactions and continuously learning from each execution, the mechanism adapts to contention effects (such as degraded performance when memory bandwidth is saturated despite available CPU) and produces service-time forecasts that converge toward observed behavior, enabling more accurate scheduling and fewer missed latency targets.

In an embodiment, further comprises constructing a composite cost vector C=[Cᵣ, Cₑ, C_d] representing resource allocation cost, energy consumption cost, and delay penalty cost, respectively, and wherein each component is computed through independent iterative subroutines: the resource allocation cost Cᵣ being obtained by integrating over forecasted infrastructure price functions P(t) retrieved from a pricing data feed; the energy cost Cₑ being computed from instantaneous power draw telemetry multiplied by an adaptive energy pricing coefficient updated hourly; and the delay penalty C_d being computed as the integral over the prediction horizon of the queueing delay weighted by a piecewise polynomial penalty function derived from service-level objectives, wherein the aggregate cost is determined by performing a weighted L2-norm combination of said components to reflect their relative economic significance under current operational constraints.

In one realizable implementation the controller converts economic and performance considerations into a compact three-element cost representation and computes each element with its own iterative routine so that the controller can quantitatively compare trade-offs before enacting scaling changes. The infrastructure cost element is built by querying a pricing feed (for example a cloud provider API) and mapping offered price curves onto the prediction horizon; the routine samples the price function at the same temporal resolution used by the predictive model, applies simple smoothing to remove transient spikes, and numerically integrates the sampled price×allocated-resource profile (e.g., vCPU-hours, memory GB-hours, instance-type counts) using a stable quadrature such as the trapezoidal rule to produce a forecasted resource dollar amount over the horizon. The energy element is computed in parallel by sampling instantaneous power telemetry from instrumented hosts (or by using calibrated power models when direct measurement is unavailable), multiplying each power sample by a time-aligned energy tariff coefficient that is refreshed on an hourly cadence from a tariff service or internal policy table, and summing the resulting power×price terms across the horizon to yield an estimated energy expense; the implementation includes safeguards for missing telemetry (backfilling using short EMA predictions) and an hourly re-weighting step that captures time-of-day tariff shifts. The delay/penalty element is formed by mapping predicted queueing delay trajectories into monetary penalties via a service objective mapping that is expressed as a piecewise polynomial: small delays below a soft threshold incur a low linear cost, moderate violations follow a quadratic section, and severe breaches enter a higher-order polynomial segment so that increasingly long latencies are progressively penalized more heavily; this polynomial mapping is parameterized from SLA contracts or business rules and the integral of penalty (delay (t)) over the prediction horizon is computed numerically to produce the delay penalty scalar. Once the three scalars are available they are combined into an aggregate score using a weighted Euclidean (L2) norm, i.e., aggregate=sqrt (w_r·Cᵣ²+w_e·Cₑ²+w_d·C_d²), where the weights w_r, w_e, w_d are set by operational policy (for example to prioritize cost-minimization versus latency preservation) and can be adapted automatically by a higher-level controller that monitors historic outcomes and adjusts weights to meet business objectives. The implementation also includes model validation and self-calibration: after each scaling event the controller compares predicted versus realized costs, computes bias and variance statistics over a rolling window, and applies multiplicative bias corrections to the price models and penalty coefficients so subsequent estimations converge toward observed reality. Computationally, these routines are designed for streaming execution (cost increments computed incrementally per time step), with caching of price curve lookups and vectorized arithmetic to run within the same prediction cycle as queue forecasts; for example, on a ten-minute horizon sampled at one-second resolution the numerical integration and combination step is implemented as a few thousand floating point operations per candidate configuration, enabling the controller to evaluate many scaling alternatives in parallel without undue delay. Together, these mechanisms allow the system to trade off provider charges, energy spending and service lateness in a principled, measurable manner, supporting cost-aware scaling decisions that reflect current market signals, telemetry, and contractual latency commitments.

In an embodiment, the evaluating of the plurality of scaling options comprises executing a parallelized cost-to-action evaluation process wherein each scaling option is simulated as a distinct computational branch, each branch invoking the predictive queueing and cost modeling routines independently with modified input resource configurations, storing intermediate simulation results in shared memory arrays, and applying a policy update iteration in which the expected cost reduction ΔC for each scaling trajectory is calculated, ranked, and passed through a softmax selection function to probabilistically favor lower-cost options while maintaining exploration across multiple scaling paths.

In one practical implementation, the controller evaluates many candidate scaling choices by instantiating each option as an independent simulation branch that executes the full prediction-and-cost pipeline with the candidate's resource configuration as input. Each branch receives a copy of the synchronized telemetry snapshot and a modified resource vector (for example: +2 vCPUs, add one instance type B, or change memory allocation ratios), runs the queue-forecasting routine to produce predicted queue-length and delay trajectories, feeds those trajectories into the cost-evaluation subroutines described earlier, and emits a scalar expected cumulative cost for the branch. To make this tractable at scale, branches are executed in parallel across a thread or actor pool where each worker performs vectorized numerical operations and reuses cached model artifacts (such as the current resource-performance matrix and price curve lookups), so that common computation is not redundantly repeated for each candidate. Intermediate time-series and scalar outputs from branches are written into pre-allocated, page-aligned shared memory arrays using atomic append indices or per-branch offsets to avoid allocation overhead; this design minimizes memory traffic and enables very fast aggregation of results once the branch simulations complete.

Operational safeguards and implementation details ensure correctness and responsiveness. Branches are pruned early when quick lower bounds indicate they cannot beat the current best (e.g., when projected delay penalties already exceed an allowable threshold), reducing wasted computation. Synchronization barriers ensure that shared arrays are only aggregated once all active branches reach a well-defined checkpoint; lightweight per-branch watchdog timers prevent stragglers from delaying the decision cycle. The entire evaluation loop is designed to complete within a single prediction cycle: for example, by limiting the number of simultaneously considered branches through heuristic preselection and by exploiting SIMD/vectorized arithmetic on modern CPUs or parallel actor pools, the controller can evaluate an order of magnitude more candidate trajectories than a serial approach for the same wall-clock time. In practice this results in more cost-effective scaling choices because the system considers a richer set of alternatives (including moderate, aggressive, and mixed resource mixes) while still producing decisions within the operational latency budget, thereby reducing both overspend and unnecessary oscillatory scaling actions.

In an embodiment, the selecting of the optimal scaling action further comprises implementing a two-stage decision process in which a primary selector computes a baseline scaling index corresponding to the minimum projected operational cost and a secondary stabilizer applies a hysteresis constraint computed as a function of the recent variance in queue length and task latency metrics, wherein scaling actions are suppressed if the expected cost improvement of the new configuration relative to the current configuration is smaller than a predetermined hysteresis threshold.

In one realizable implementation the selection routine is split into two cooperating stages so that the controller chooses economically attractive actions while avoiding churn caused by transient measurement noise. First, a primary selector ingests the synchronized telemetry snapshot, the set of simulated scaling branch outcomes, and the aggregated cost estimates for each candidate configuration, and computes a scalar baseline scaling index for every candidate by normalizing its projected aggregate cost against the current configuration and any operator-specified penalties (for example, instance boot cost or minimum-provisioning constraints). The baseline index may be produced by a constrained optimization or discrete search: for continuous adjustment it can be the result of a bounded gradient-descent step on the weighted-cost surface, while for discrete instance-level choices it is the rank-normalized score derived from the parallel simulation outputs; in either case the index directly encodes the expected net benefit of moving to that configuration after accounting for provisioning latency and one-time transition costs. The secondary stabilizer then inspects recent operational variability—quantified from the sliding-window variance and higher-order moments of queue length and task latency—and computes a context-aware suppression threshold that scales with volatility. If the best candidate's baseline index indicates an expected cost improvement smaller than this dynamically computed threshold, the stabilizer delays or suppresses the change; when suppression occurs the controller may instead apply a lighter-weight remedial action such as temporary priority shifting or short-term thread-pool tuning to mitigate risk without committing to full scaling. Additional hysteresis mechanisms are applied to prevent flip-flopping: a minimum hold-time prevents a reversed decision before T_hold seconds have elapsed, and a cooldown window requires M consecutive prediction cycles to agree on the same direction before enactment. In practice this two-stage approach yields materially steadier behavior—for example, during small oscillations around a utilization setpoint the stabilizer will block marginal downscales that would otherwise cause immediate upscales shortly after, reducing wasted provisioning cycles, lowering churn-related overheads (such as instance startup fees), and preserving service continuity. The implementation also records decision rationale and confidence metrics so that suppressed candidates can be re-evaluated automatically if volatility subsides or if the expected benefit grows, ensuring the controller remains responsive when the operational signal is robust.

In an embodiment, the executing of the selected scaling action through the scaling actuation interface further comprises serializing the scaling instruction sequence into a communication packet conforming to a secure orchestration protocol, performing digital signing of the packet using a cryptographic signature derived from a system key, initiating transmission over a low-latency control channel, awaiting acknowledgment from the orchestration endpoint within a bounded timeout period, and verifying successful execution by cross-referencing the newly instantiated resource identifiers against a resource inventory table maintained in memory, wherein unsuccessful or delayed acknowledgments trigger a rollback subroutine that reverts the scaling decision to the last verified stable configuration.

In a realizable implementation the controller converts a chosen scaling plan into a verifiable, atomic actuation workflow that guarantees authenticity, prevents replay, and ensures recoverability if the orchestration endpoint fails or returns unexpected states. The workflow begins by encoding the scaling steps as a deterministic instruction sequence—each step annotated with a unique sequence number, a monotonic nonce, and a UTC timestamp—to produce a canonical payload (for example a compact JSON or protobuf message body) that describes the desired resource types, allocation parameters, and any transition semantics (drain-then-terminate, warm-boot, capacity reservation, etc.). Before transmission this payload is serialized and canonicalized and then cryptographically signed using the controller's system key; in typical deployments the signature uses an industry-standard algorithm such as ECDSA over curve P-256 or RSA-2048 with SHA-256, and the controller retains the private key in a hardened key store or HSM while the orchestration endpoint verifies signatures against the controller's public certificate. To protect confidentiality and integrity in transit the signed packet is carried inside a secure orchestration channel (for example gRPC over mutual TLS, or an authenticated message queue with TLS and token-based access), and the protocol includes explicit replay protection by validating the nonce/timestamp and rejecting out-of-window requests.

The controller transmits the signed instruction packet over a low-latency control path and then waits for a bounded acknowledgment window during which the orchestration endpoint must return a cryptographically verifiable receipt that includes the operation identifier and the list of newly allocated resource identifiers (for example instance UUIDs, container IDs, or node names). A strict timeout policy governs progress: if no acknowledgment is received within the configured bound, the controller moves to a predefined mitigation path that can include exponential backoff retried attempts over alternative control channels, a failover to a secondary orchestration endpoint, and ultimately triggering a rollback. Upon receiving an acknowledgment the controller cross-references the returned resource identifiers against its in-memory resource inventory table, which maintains expected configuration parameters, allocation timestamps, and lifecycle state machines. Verification includes sanity checks (matching instance types, expected region/zone, and security groups), checksum validation of any returned configuration blobs, and confirmation that provisioned resources have reached an operational health state (for example node joined to cluster and marked Ready, or VM boot completed and passed boot-health probes). If any of these checks fail—or if acknowledgments are delayed beyond the timeout—the rollback subroutine executes a deterministic reversal: it issues signed deprovisioning commands (or a compensating transaction) that remove partially created resources and restore routing/traffic weights or scheduling policies to the last known-good configuration, and it records the failure and rollback rationale in an append-only audit log for later forensic analysis.

The implementation hardens correctness through idempotent command semantics (so re-sent packets do not cause duplicate allocations), versioned instruction schemas (to tolerate controller/orchestrator upgrades), and a two-phase or transactional confirmation where a provisional shadow deployment can be exercised and validated before committing the change globally. Key-management practices—periodic key rotation, certificate revocation checking, and storing signing keys in HSMs—reduce the risk of compromised control. Operational safeguards such as watchdog timers for straggler resources, a dead-letter queue for manual intervention, and automated drain-and-evacuate procedures for rollback ensure that partial failures do not leave inconsistent states or stranded billing. For example, when provisioning a node pool in a Kubernetes cluster, the controller signs a protobuf instruction to the orchestration API, verifies returned node UUIDs and their Ready state within the timeout window, and if a node fails to join, invokes the deprovisioning transaction and restores the prior autoscaler target; this guarantees that scaling decisions are executed securely, deterministically, and recoverably while preserving service continuity and resource accounting.

In an embodiment, the evaluating of potential scaling trajectories for each simulated state over the prediction horizon further comprises executing a Monte Carlo ensemble simulation in which multiple stochastic realizations of workload evolution are generated, each realization being initialized with a random perturbation of the observed arrival and service rate parameters within empirically determined confidence bounds, computing the expected cumulative cost for each trajectory, and determining the optimal scaling trajectory by selecting the one with the minimum mean and lowest standard deviation of cumulative operational cost across all realizations.

In one practical realization, the controller evaluates prospective scaling trajectories by running a Monte Carlo ensemble that produces many plausible futures for workload evolution and then uses the ensemble statistics to choose a robust plan. The process begins by deriving empirical confidence bounds for the current arrival and service rate estimates from the recent telemetry history (for example, using a bootstrapped estimate of the sample standard error or an exponentially-weighted variance window), and then initializing each ensemble member by randomly perturbing the baseline parameters within those bounds using pseudo-random draws (Gaussian or another fit distribution) so that the ensemble spans likely deviations rather than pathological extremes. Each realization is advanced across the prediction horizon by applying the same queue-forecasting and cost-evaluation routines used for deterministic branches; this yields a cumulative operational cost time-series for every candidate scaling trajectory under that particular stochastic perturbation. After running the ensemble (typically hundreds to low thousands of realizations depending on computational budget and required confidence), the controller computes per-trajectory summary statistics—notably the sample mean and standard deviation of cumulative cost—and ranks trajectories not only by expected cost but also by outcome variability. Selection may then follow a Pareto-aware or composite rule that favors trajectories with both low average cost and controlled volatility (for example selecting the trajectory with the minimum mean among those whose standard deviation is below a threshold, or minimizing mean+α·std where α is an operator-set risk aversion parameter). To improve statistical efficiency and reduce runtime, the implementation can apply variance-reduction methods such as importance sampling (oversampling rare but costly scenarios), control variates drawn from cheap analytic approximations, or stratified sampling across arrival-rate quantiles; ensemble members are executed in parallel using thread or actor pools and intermediate results are aggregated into shared memory buffers to avoid I/O bottlenecks. The runtime also enforces computational safeguards: a maximum wall-clock budget for ensemble evaluation, early-abort pruning of dominated trajectories once sufficient confidence is reached, and incremental refinement where a coarse initial ensemble identifies promising candidates that are then re-simulated with higher-fidelity sampling. In a production example for a web-service cluster, this ensemble-based approach prevents the controller from selecting a low-average-cost scaling plan that is highly sensitive to plausible burst patterns; instead the chosen trajectory delivers reliably low cumulative cost across likely workload realizations, reducing the probability of costly SLA breaches while keeping provisioning conservative enough to avoid repeated oscillation. The result is a decision mechanism that is explicitly risk-aware, statistically grounded, and computationally tractable for online usage.

In an embodiment, the determining of the confidence level associated with each predicted queueing delay comprises computing the variance of prediction residuals over a sliding history window, estimating uncertainty using an exponentially weighted moving variance estimator, and mapping said uncertainty to a confidence score through an inverse sigmoid transformation, wherein the aggressiveness of the scaling action is adjusted proportionally by modulating the scaling decision step size according to the confidence score. In an embodiment, the executing of predictive and cost evaluation computations is optimized through a pipelined execution structure implemented over multi-core computational threads, wherein distinct computational phases including telemetry normalization, queue prediction, cost evaluation, and decision computation are executed in overlapped stages with inter-thread data transfer through shared cache memory segments, and wherein synchronization barriers are inserted after each prediction cycle to ensure consistency of shared data structures before proceeding to actuation.

In a practical implementation the heavy predictive and cost-evaluation work is arranged as a true processing pipeline across multiple CPU cores so that telemetry normalization, queue forecasting, cost computation, and decision logic progress in overlapped stages rather than as a single monolithic task; incoming telemetry is ingested by a dedicated input thread that writes into cache-aligned, double-buffered ring structures (or lock-free SPSC queues) to avoid heap allocation and minimize cache-miss penalties, worker threads pinned to specific cores perform normalization and Kalman/cubic-spline alignment on windowed slices, the normalized windows are handed off (by pointer swap or atomic epoch toggle) to a prediction stage that runs the stochastic/Monte-Carlo simulations using vectorized numerical kernels, and the resulting time-series are forwarded to cost-evaluation threads which execute the energy/pricing integrators and penalty mappings before a final decision thread computes the selection index and actuating instruction. Careful attention is given to memory layout and NUMA locality—buffers are allocated on the same NUMA node as the threads that consume them, data structures are padded to avoid false sharing of cache lines, and intermediate arrays are pre-allocated and reused to eliminate allocation jitter. Inter-thread communication is implemented with light-weight synchronization primitives (atomic flags or futex-based semaphores) and a barrier or epoch fence is inserted at the end of each prediction cycle to ensure all stages have reached a consistent state before the actuation step commences; this barrier both enforces a consistent snapshot for verification and prevents races when the decision routine cross-references inventory or issues signed control packets. The pipeline also implements pragmatic controls for real-world variability: backpressure signals from downstream stages throttle input ingestion during overload, lower-fidelity fast-paths (coarse-grained prediction or analytic approximations) are used when wall-clock budgets are tight, and watchdog timers detect and recover from stalled worker threads. Instrumentation exposes per-stage latencies and queue depths so that stage parallelism and worker counts can be auto-tuned at runtime, and safety checks validate that the data exchanged across stages matches expected checksum/sequence numbers before commitment. By structuring the computation as an overlapped, NUMA-aware, cache-friendly pipeline with explicit synchronization points and graceful degradation modes, the controller attains much lower end-to-end decision latency and higher sustained throughput than a serial implementation while preserving deterministic consistency at the actuation boundary.

In an embodiment, the step of predicting the future queueing state further comprises dynamically adjusting the simulation granularity based on the variance of recent task arrival intervals, such that when high burstiness is detected, the prediction step size Δt is reduced according to an inverse proportional relationship Δt=k/(1+σₐ), where da represents the standard deviation of arrival intervals and k is a calibration constant, and wherein during low-variance intervals, Δt is adaptively enlarged to conserve computational resources without degrading predictive accuracy.

In one concrete implementation the queue-prediction engine continuously measures recent arrival-time variability and uses that measurement to change the simulation time-step so the predictor spends compute where it matters most. Concretely, the controller computes the standard deviation of inter-arrival intervals, σₐ, over a sliding window (for example the last M arrivals, where M is chosen to capture a few seconds to a few minutes of history depending on workload dynamics) and optionally smooths this value with an exponentially-weighted moving average to avoid reacting to single outliers. The predictor then computes a step size Δt according to the inverse-proportional rule Δt=k/(1+σₐ), subject to hard bounds Δt_min≤Δt≤Δt_max to maintain numerical stability and to respect actuation latency budgets; k is a calibration constant chosen during deployment to set the baseline temporal resolution (for example k between 0.1-1.0 seconds in many real-time services). Thus, when σₐ grows large during bursty intervals Δt contracts (e.g., with k=0.5 s and σₐ=5, Δt≈0.5/6≈0.083 s) which yields finer-grained simulation steps that better capture fast queue dynamics, whereas when arrivals are stable (Ga small) Δt increases toward k, reducing the number of simulation iterations and conserving CPU without materially affecting forecast fidelity. Practical safeguards include (i) enforcing a minimum Δt_min to prevent excessive compute under pathological Ca values, (ii) applying a step-change limiter or hysteresis (for example only allow Δt to change by at most 20% between cycles) to avoid oscillatory resizing of computational load, and (iii) re-evaluating Δt at coarse-grained control epochs rather than every micro-update to amortize overhead. The adaptive step-size interacts with other prediction components: Monte-Carlo or ensemble simulations inherit the dynamically selected Δt so that ensemble members remain comparable, and convergence checks (e.g., the stability threshold on queue-length averages) are normalized to the current Δt so stopping criteria remain consistent. Implementation-level optimizations—such as switching to analytic fast-path approximations when Δt exceeds a high threshold, or dropping to coarser-grained probabilistic summaries during very long horizons—help maintain total wall-clock budgets for decision cycles. In operation this mechanism concentrates computational effort during volatile periods to preserve predictive accuracy (capturing sharp ramp-ups or short spikes) while substantially lowering average CPU and energy consumption during calm periods, enabling the controller to deliver timely, high-fidelity forecasts when they matter and to scale its own resource usage when precision can be safely relaxed.

In an embodiment, the determining of expected processing duration further comprises a feedback correction mechanism that compares the predicted duration for each task with the actual completion time upon task termination, computes a residual error vector for each workload type, and applies an incremental model weight update using an online least mean squares (LMS) correction rule of the form w(t+1)=w(t)+η·e(t)·x(t), where η is a learning rate parameter, e(t) the prediction error, and x(t) the corresponding workload feature vector.

In an embodiment, the computing of total projected operational cost comprises periodically validating the accuracy of cost estimation models by comparing predicted versus actual cost realizations after scaling events, computing an error margin distribution over a recent observation window, and applying statistical bias correction to each cost component by recalibrating cost coefficients according to the median bias ratio.

Implementation details favor online, incremental numerics to scale with high-frequency events: the controller uses streaming algorithms (Welford-like one-pass estimators for means and variances, running medians via reservoir sampling or digest structures) to maintain distributions without full re-scan, and stores per-event records in a compact ring or time-series DB for auditability. Recalibration runs are scheduled periodically (for example hourly or daily) and may also be triggered by detected model drift (a statistically significant change in bias or variance). All recalibrations are logged in an append-only audit trail with before/after coefficients and sample statistics to support rollback and regulatory review. Prior to committing a new set of coefficients the controller can run a shadow evaluation where the adjusted models score recent historical events offline to estimate the effect of the change and confirm improvement according to a chosen metric (median absolute error reduction).

In an embodiment, the evaluating of scaling options includes a temporal coherence constraint that restricts scaling transitions to occur only when at least M consecutive prediction cycles indicate the same optimal scaling direction, where Mis dynamically computed as a function of the average queue length volatility index, and wherein the predicting of the future queueing state and computing of expected processing duration are executed within a shared computational workspace maintained in volatile memory, wherein intermediate variables including arrival rate estimates, predicted queue length vectors, and task service matrices are stored in double-buffered memory segments, alternating between read and write access at successive prediction cycles to prevent concurrent memory contention and to guarantee atomic consistency during multi-threaded predictive computation.

In a practical deployment the controller enforces a temporal coherence rule that prevents rapid flip-flopping of resource configurations by requiring that an indicated scaling direction (up, down, or no-change) be stable for a short run of consecutive prediction cycles before any transition is committed; the required run-length M is not fixed but is computed continuously from a volatility measure so that the controller becomes more conservative when the workload is noisy and more responsive when the workload is calm. Concretely, the system maintains a volatility index derived from recent queue-length statistics (for example a normalized combination of the short-window variance, mean absolute deviation and burst-frequency) and maps that index to an integer hold-count via a simple monotonic function are deployable constants-so that high volatility raises M and low volatility lowers it. During operation each prediction cycle emits a recommended direction; a compact state machine tallies consecutive identical recommendations and only when the tally reaches M does the decision pipeline allow the two-stage selector and actuation interfaces to proceed to provisioning. This mechanism reduces wasted provisioning work and billing churn by filtering short-lived signals while still allowing decisive action when the environment exhibits persistent change; suppressed recommendations remain recorded with their confidence and cost signals so they can be re-evaluated automatically if the persistence condition later becomes satisfied.

To support the required frequent, low-latency prediction cycles in a multi-threaded runtime, the predictor and duration-estimation components operate inside a shared, volatile workspace designed for atomic, high-throughput access. Incoming arrival-rate estimates, predicted queue vectors, and task-service matrices are materialized in double-buffered memory segments so that one buffer is designated read-only for consumer threads while the other is concurrently written by producer threads; at the end of a cycle the system atomically swaps the buffer roles (for example via an atomic epoch toggle) thereby guaranteeing that readers never observe partially-written structures and writers never block on long-running reads. Memory layout is engineered for cache efficiency and NUMA-awareness: arrays are page-aligned, padded to avoid false sharing, and allocated on the NUMA node local to the threads that will consume them. Lightweight synchronization primitives (atomic flags, epoch counters) coordinate buffer swaps and enforce a cycle-level barrier only when necessary, avoiding full-lock contention while still ensuring consistent snapshots for decision logic and actuation. Additional runtime safeguards-such as bounds on buffer age, watchdog detection of stalled producers/consumers, and graceful fallback to a validated coarse snapshot if a swap fails-ensure that occasional thread stalls do not lead to corrupted predictions or unsafe actuation. Together, the temporal-coherence gating and the double-buffered shared workspace produce a control loop that is both stable under noisy conditions and capable of delivering consistent, race-free inputs to the scaling decision and actuation machinery, thereby lowering provisioning churn, improving predictability of outcomes, and preserving correctness in heavily parallelized online environments.

In an embodiment, the selecting of the optimal scaling action comprises computing a sensitivity index representing the gradient of projected operational cost with respect to incremental resource additions or removals, wherein the scaling direction is chosen according to the sign of the sensitivity index, and the magnitude of the scaling adjustment is determined through numerical optimization using a bounded gradient descent iteration with an adaptive learning coefficient, and wherein the computing of the delay penalty cost comprises constructing a cumulative distribution function of predicted task waiting times, computing quantile boundaries corresponding to service-level objective percentiles, and integrating the penalty over only the tail region of the distribution exceeding the predefined latency threshold, such that penalty computation emphasizes outlier delays while preserving computational efficiency by ignoring compliant portions of the workload distribution.

The sensitivity-driven resource update and the tail-focused delay penalty are combined in the selection step: the gradient-guided optimizer uses the sensitivity index (including its sign and magnitude) to propose candidate adjustments while the delay-penalty computation supplies accurate, computationally compact signals about SLA-risk concentrated in the tail. A final constrained selection respects hysteresis, temporal-coherence gates, and confidence-modulation so that even a negative sensitivity (suggesting scale-up) is withheld if tail penalties are highly uncertain or if the optimizer's adaptive step size falls below a minimum. In practice this results in resource changes that are quantitatively justified by marginal cost reductions, targeted to reduce rare but costly latency violations, and bounded to prevent excessive or oscillatory provisioning.

In an embodiment, the evaluating of potential scaling trajectories further comprises computing a trajectory stability score for each candidate configuration by analyzing the variance of predicted queue length under simulated perturbations of arrival rate and service rate parameters, wherein configurations exhibiting variance above a stability tolerance threshold are discarded prior to cost comparison, and wherein the executing of the selected scaling action includes initiating a dual-phase confirmation process in which an initial provisional scaling command is executed in a shadow deployment mode for a test duration shorter than the average queueing cycle, monitoring instantaneous utilization and latency response, and finalizing the scaling only if the observed performance metrics deviate from predicted values by less than a predefined validation tolerance.

In one realizable implementation the controller first filters candidate scaling configurations by estimating how sensitive each proposal is to plausible fluctuations in workload and service capacity, producing a numeric trajectory stability score that summarizes the dispersion of projected queue-length outcomes under stochastic perturbations; concretely, for each candidate the system generates a small ensemble of perturbed simulations by drawing arrival-rate and service-rate perturbations from empirically derived confidence intervals (for example to or bootstrapped percentiles), runs the queue-forecast for each perturbation, computes the sample variance (or coefficient of variation) of the resulting queue-length time series across ensemble members, and reduces those time-series to a single stability metric (such as the time-averaged variance or the maximum-percentile deviation). Configurations whose stability metric exceeds a policy-defined tolerance are pruned from further economic comparison because their outcome variability implies high operational risk or likelihood of costly rollbacks; this early-stage culling saves computational effort and avoids considering options that are likely to produce unpredictable behavior. For configurations that pass the stability gate, the controller performs a two-phase enactment: it first issues a provisional scaling command into a shadow deployment environment where the change is applied to non-production traffic (or to a canary subset) for a short test interval chosen to be shorter than the system's average queueing cycle (for example one-half to three-quarters of the measured mean cycle), thereby allowing rapid validation without exposing the entire workload to unproven changes. During the shadow interval the system continuously monitors instantaneous utilization, request latency percentiles, error rates, and other health probes; these observed trajectories are compared in near-real time against the predicted profiles using a compact validation metric such as normalized mean absolute deviation or a bounded Kolmogorov-Smirnov distance on latency quantiles. If the observed performance deviates from prediction by less than the configured validation tolerance (for instance less than 5-10% MAE on key percentiles and no newly introduced error spikes), the provisional change is promoted to full production and the inventory, billing, and capacity accounting records are updated atomically. If the shadow test fails the controller either rolls back the provisional resources and marks the configuration as invalid for a decay period, or it enters an automated remedial loop that attempts conservative adjustments (smaller step sizes, different instance families, or partial traffic drainage) before re-testing. Implementation details include isolating shadow deployments on separate resource pools to avoid noisy neighbor effects on production, tagging all provisional resources with audit metadata for fast reclamation, and setting the shadow duration adaptively based on the measured queueing autocorrelation so that validation is both fast and statistically meaningful. By preferring stable trajectories and verifying outcomes in a lightweight, reversible manner, this approach reduces the risk of large, unanticipated performance swings, lowers the incidence of costly fallback operations, and ensures that only scaling actions which behave as predicted under realistic perturbations are permitted to affect live service.

The present invention provides a method and system for cost-aware autoscaling of artificial intelligence workloads using predictive queueing models, wherein both the techniqueic operation and physical embodiment are designed to achieve proactive, low-latency, and cost-efficient scaling of computational resources. The technique operates as an integrated feedback control process in which workload telemetry is continuously analyzed, future queue states are predicted using stochastic modeling, scaling costs are estimated through a dynamic pricing function, and optimal scaling actions are determined using reinforcement learning-based decision optimization. The hardware-integrated controller device executes these computations in real time and actuates scaling commands across distributed computing infrastructures.

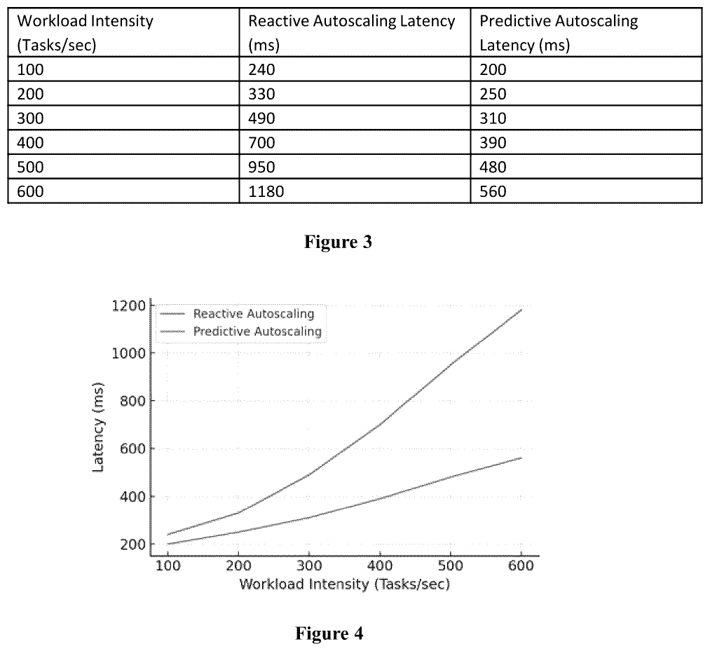

FIG. 3 illustrates a table depicting a comparative analysis between reactive autoscaling and the claimed predictive cost-aware autoscaling system under increasing workload intensity. As shown in FIG. 3, latency in conventional reactive autoscaling systems increases exponentially as workload intensity rises beyond 400 tasks per second, reaching nearly 1180 ms at peak load. In contrast, the predictive queueing-based system of the present invention maintains near-linear latency growth, with latency capped below 600 ms under the same conditions. This demonstrates the technical effect of proactive prediction and optimized scaling decisions that prevent queue congestion, achieving approximately 45-50% reduction in response latency at higher loads.

FIG. 4 illustrates a line chart showing the comparative latency response of reactive versus predictive autoscaling mechanisms. The slope of the predictive autoscaling curve remains gradual and controlled, reflecting the invention's ability to pre-emptively scale resources using stochastic queueing forecasts. The reduction in slope beyond 300 tasks per second indicates reduced latency sensitivity due to adaptive decision-making and proactive resource allocation implemented by the system.

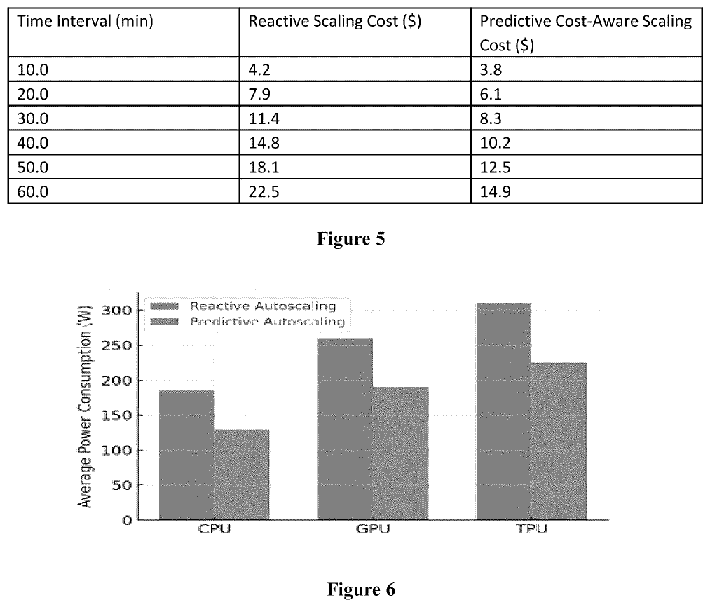

FIG. 5 illustrates a table depicting the total operational cost incurred over time under reactive and predictive cost-aware autoscaling conditions. As evident from FIG. 5, the total operational cost under reactive scaling grows non-linearly due to excessive instance allocation during transient workload spikes. In contrast, the proposed system maintains stable cost progression, saving approximately 34% at the 60-minute mark through predictive cost estimation and reinforcement learning-based optimization. This quantitative reduction in expenditure directly reflects the system's ability to minimize redundant scaling actions while maintaining service-level compliance.

FIG. 6 illustrates a bar chart showing comparative energy consumption across central, graphical, and tensor processing units during workload scaling. The predictive system demonstrates significantly lower power usage, with reductions of approximately 30% for CPUs, 27% for GPUs, and 25% for TPUs compared to conventional reactive systems. This improvement arises from the invention's cost-aware scaling mechanism that dynamically integrates energy consumption into its optimization function, preventing over-provisioning and enhancing overall system sustainability.

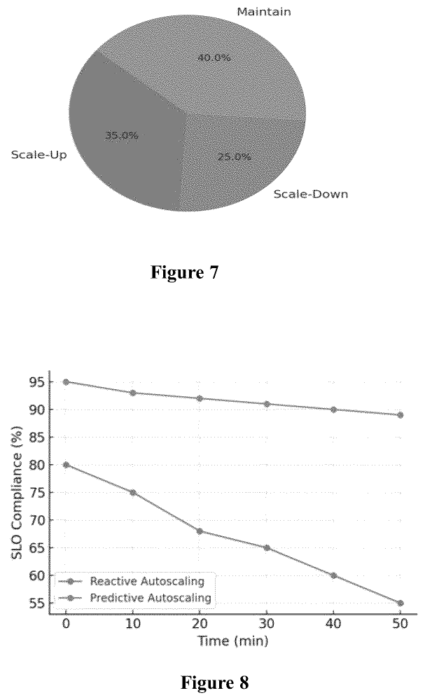

FIG. 7 illustrates a pie chart showing the distribution of scaling actions performed by the predictive cost-aware autoscaling system. The distribution reveals a balanced ratio of scale-up, scale-down, and steady-state maintenance actions, indicating stable operation with minimal oscillation. Compared to reactive scaling, which performs frequent scale-ups, the predictive approach achieves equilibrium by forecasting workload dynamics accurately, resulting in smoother transitions and reduced infrastructure churn.

FIG. 8 illustrates a line chart showing service-level objective (SLO) compliance over time under reactive and predictive autoscaling conditions. The predictive system consistently maintains over 90% compliance, whereas the reactive system declines below 60% during sustained workload stress. This outcome demonstrates the technical advantage of the proposed predictive queueing mechanism, which anticipates congestion and maintains target latency levels through proactive cost-optimized scaling actions.

The present invention involves a predictive queueing technique that models the stochastic behavior of incoming workloads. The technique begins with telemetry collection performed by a data acquisition unit. This unit receives data from distributed compute nodes, including task arrival timestamps, task completion times, queue lengths, and resource utilization metrics such as processor load, memory usage, and accelerator occupancy. The data is first normalized and synchronized through clock-offset compensation to ensure temporal coherence across distributed nodes. Each telemetry record is then classified into workload categories based on computation type (for example, convolutional neural inference, natural language processing, or graph learning) to enable context-specific prediction.

Once the telemetry is prepared, the predictive queueing unit models the arrival process of tasks using a Markov-modulated Poisson process (MMPP). In this approach, workload arrivals are represented as a Poisson process whose rate parameter varies over time according to a hidden Markov chain. Each hidden state represents a distinct workload intensity, such as low, medium, or high load conditions. The transition probabilities between states are dynamically updated by a maximum likelihood estimation computed from recent workload observations. This allows the system to adapt to bursty or periodic workload patterns that characterize AI inference pipelines, particularly those serving user-dependent requests. The queueing model continuously computes an estimated arrival rate and the expected waiting time using analytical queueing equations derived from MMPP behavior.

In parallel, the service time prediction processor computes the expected service duration for each incoming task. This processor employs a neural network-based prediction model trained on historical task execution traces, resource configurations, and hardware utilization data. The model accepts as input parameters such as task type, model architecture, input data size, batch size, and hardware type (for example, CPU, GPU, or TPU). The neural network outputs a predicted service time distribution for the upcoming time window. To account for non-stationary system dynamics, the model periodically retrains itself using feedback data collected from executed workloads, thereby improving accuracy over time. The predicted service time is then combined with the forecasted arrival rate to compute an expected queue utilization ratio, which directly reflects the anticipated delay level in each node.

The cost estimation unit plays a pivotal role in making the autoscaling process economically efficient. It receives inputs from the predictive queueing unit and computes a total projected operational cost for each possible scaling decision. The total cost comprises three major components: a resource allocation cost, a delay cost, and an energy cost. The resource allocation cost is computed based on real-time cloud infrastructure pricing models, which may include on-demand, reserved, and spot pricing schemes. The delay cost is derived from predicted waiting time, weighted by a penalty function associated with service-level objective (SLO) violations. The energy cost is determined from the estimated power consumption of active resources, which is measured through telemetry or approximated through a power-performance model. These three cost components are combined into a unified cost function that dynamically evolves as workload patterns and pricing conditions change.

The technique then proceeds to the scaling decision phase, where multiple scaling options are evaluated—such as adding resources, releasing resources, or maintaining the current configuration. The scaling decision unit employs a reinforcement learning (RL) technique to determine the optimal action. The RL-based optimization treats each system state as a tuple comprising predicted queue length, average waiting time, and total cost metrics. For each state, the technique evaluates a set of possible actions and computes a state-action value representing the expected cumulative cost if that action were chosen. A temporal difference learning method updates these values based on observed rewards after each scaling action is executed. The reward function is inversely proportional to the total cost, meaning that decisions leading to low-cost and low-latency outcomes are reinforced over time. This continuous learning process enables the system to adapt its scaling policy dynamically without human intervention or predefined thresholds.

To execute the selected scaling action, the hardware-integrated autoscaling controller device performs real-time control signal generation. The device includes a predictive computation processor, a cost-decision processor, and a scaling actuation interface. The predictive computation processor executes the queueing and neural prediction computations in low-latency fixed-point arithmetic using embedded tensor cores. The cost-decision processor concurrently performs cost evaluations through parallel arithmetic logic units optimized for iterative function minimization. The scaling actuation interface translates the optimal scaling action into orchestration-specific commands compatible with platforms such as Kubernetes or OpenStack, transmitting them through secure communication channels using RESTful or MQTT protocols. This ensures that new virtual machines, containers, or hardware accelerators are provisioned or decommissioned almost instantaneously.

A key feature of the technique is its closed feedback control loop. Each scaling action generates feedback telemetry containing the resulting latency, throughput, queue length, and actual cost metrics. This feedback is ingested by the data acquisition unit and used to refine both the predictive queueing parameters and the reinforcement learning policy. The predictive queueing parameters—such as transition probabilities and service rate estimates—are updated through recursive estimation techniques to maintain alignment with real-time workload behavior. Simultaneously, the reinforcement learning policy is adjusted using the difference between expected and observed cost performance, allowing the system to continually improve decision quality. The feedback loop ensures that prediction inaccuracies are progressively minimized and that scaling remains stable even under rapidly changing conditions.

The invention also includes an uncertainty-aware decision mechanism embedded within the predictive queueing unit. For every predicted queue delay, an uncertainty quantification processor computes a confidence score based on statistical variance across recent predictions. The scaling decision unit incorporates this uncertainty into the final decision by adjusting the aggressiveness of scaling actions. When prediction confidence is high, the scaling action is executed immediately; when confidence is low, the system adopts a conservative stance, avoiding premature scaling. This mechanism prevents oscillatory behavior common in reactive autoscaling systems and ensures decision stability even under unpredictable workload bursts.

The technique further supports multi-service and multi-tenant scaling coordination. In distributed AI pipelines comprising interdependent microservices, each service may have a separate queue and processing latency. The system uses dependency-aware scheduling to ensure coordinated scaling. The predictive queueing unit models the service chain as a composite queueing network, where the output rate of one queue serves as the input rate for the next. Scaling decisions for upstream services are made with knowledge of downstream service conditions, maintaining balanced throughput and preventing congestion at intermediate stages. For multi-tenant environments, the cost estimation unit applies tenant-specific cost functions that weight latency and expenditure according to predefined service-level agreements. This enables differentiated scaling strategies across workloads sharing common infrastructure.

To address operational sustainability, the technique incorporates energy-aware scaling. The energy cost component of the total projected cost is calculated using a power consumption estimator that models the energy draw of active computational units as a function of utilization and temperature. This estimator feeds back into the cost optimization function, penalizing high-energy states. The reinforcement learning policy therefore learns to prefer scaling configurations that not only minimize operational expenditure but also reduce energy consumption, contributing to environmentally responsible computing.

The hardware embodiment of the system is optimized for continuous operation in both cloud and edge environments. The autoscaling controller device is implemented as a Predictive Autoscaling Controller Unit (PACU) enclosed within a thermally regulated metallic chassis containing passive convection pathways and vapor chamber heat spreaders. The device's processors operate under low-power conditions suitable for continuous operation. The PACU includes non-volatile memory to store model weights, cost tables, and policy data, allowing rapid recovery after power interruptions without retraining. Communication interfaces, including Ethernet and fifth-generation cellular links, enable the PACU to operate as an independent node in decentralized edge deployments, executing the autoscaling technique locally without dependence on central control servers.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A computer implemented method for cost-aware autoscaling of artificial intelligence workloads using predictive queueing models, the method comprising the steps of:
receiving a plurality of workload parameters including real-time task arrival rate, task completion statistics, queue length values, and hardware utilization metrics from a plurality of distributed computing nodes executing artificial intelligence workloads;
processing the received parameters to normalize and time-align telemetry streams from heterogeneous sources to ensure synchronized input for predictive analysis;
predicting a future queueing state by modeling the incoming task arrivals through a stochastic process that captures dynamic workload burstiness, and determining an expected waiting time and expected queue length for each computational node based on historical task execution and current system conditions;
determining an expected processing duration for each task by applying a learned service time estimation model trained using prior workload traces and resource utilization patterns;
computing a total projected operational cost associated with each potential scaling decision, wherein the total projected operational cost comprises a resource allocation cost computed from current and forecasted infrastructure pricing information, and a delay cost computed from predicted queueing delay weighted by a service-level objective penalty function;
evaluating a plurality of scaling options including scaling up resources, scaling down resources, or maintaining a current configuration by comparing the total projected operational cost corresponding to each option;
selecting an optimal scaling action that minimizes the total projected operational cost while ensuring that latency and throughput remain within predefined performance thresholds; and
executing the selected scaling action through a scaling actuation interface that communicates scaling commands to a cloud or edge orchestration system for provisioning or de-provisioning of computing resources, wherein the processing of the received workload parameters to normalize and time-align telemetry streams from heterogeneous sources comprises continuously receiving asynchronous telemetry updates through independent communication channels, buffering each incoming telemetry record in a circular memory buffer indexed by reception timestamp, estimating latency skew for each node by computing a time-difference distribution of successive samples, and performing dynamic alignment by adjusting each incoming record using an offset correction value obtained from a convergence iteration of a Kalman-based clock offset estimator, wherein each corrected data point is resampled through cubic spline interpolation to achieve uniform temporal resolution, and wherein the resulting synchronized telemetry dataset is segmented into discrete, non-overlapping analysis windows that serve as consistent input to the subsequent predictive modeling stage, and wherein the predicting of the future queueing state further comprises executing a continuous stochastic simulation loop in which:
a) a baseline arrival rate is initialized from the exponential moving average of the last N observed inter-arrival intervals;
b) for each iteration within a rolling prediction horizon, a probabilistic perturbation term is generated using a Gaussian random variable whose variance is proportional to the instantaneous coefficient of variation of recent arrivals; and
c) convergence is declared when the absolute difference between the last two predicted queue length averages is less than a dynamically computed stability threshold obtained by evaluating the mean absolute deviation over the last k windows of actual telemetry.

2. The method of claim 1, wherein the predicting of the future queueing state comprises continuously estimating the arrival rate of tasks using a Markov-modulated Poisson process, wherein the process transitions among multiple arrival intensity states based on real-time telemetry, and wherein each transition probability is adaptively updated using a likelihood estimation computed from recent arrival statistics to reflect non-stationary workload dynamics, wherein the determining of the expected processing duration comprises computing, by a neural prediction model, the service time for each task as a function of workload type, current hardware configuration, and recent interference patterns across computational nodes, and wherein said neural prediction model is trained using historical workload datasets annotated with completion time metrics and resource consumption logs.

3. The method of claim 1, wherein the computing of the total projected operational cost further comprises computing a plurality of cost terms including an infrastructure usage cost determined from instance pricing models, a latency penalty cost derived from deviation from latency thresholds, and an energy cost computed from power consumption data of active resources, and summing the plurality of cost terms into an aggregate cost metric for each scaling option, wherein the evaluating the plurality of scaling options comprises applying a reinforcement learning-based optimization process, and computing a policy function mapping predicted queueing states and cost estimations to scaling actions, and wherein the policy function is updated through temporal difference learning based on feedback from executed scaling outcomes to minimize cumulative operational cost.

4. The method of claim 1, wherein the executing of the selected scaling action further comprises generating a scaling command signal formatted according to the orchestration protocol of a target infrastructure, transmitting said command through a secure communication interface, and verifying acknowledgment from the orchestration layer to confirm completion of resource instantiation or termination, wherein the receiving of the workload parameters further comprises obtaining telemetry data from a plurality of geographically distributed nodes operating under heterogeneous latency domains, and performing time synchronization using clock-offset estimation to maintain temporal alignment across the collected metrics.

5. The method of claim 1, further comprises:
performing queue prediction computations using fixed-point arithmetic to reduce latency;
executing cost evaluations in parallel using arithmetic logic circuits, and a scaling actuation interface configured to dispatch control signals to resource orchestration endpoints;
determining a confidence level associated with each predicted queueing delay; and
adjusting the aggressiveness of the scaling action proportionally to the uncertainty value;
wherein the selecting of the optimal scaling action comprises simulating multiple hypothetical future workload states over a prediction horizon, evaluating potential scaling trajectories for each simulated state using the predictive queueing model, and selecting a scaling trajectory that minimizes the expected operational cost across the prediction horizon.

6. The method of claim 1, wherein the predicting of the future queueing state further comprises executing a continuous stochastic simulation loop in which the simulated queue length is incrementally updated using a recursive equation of the form L(t+Δt)=max(0, L(t)+λ(t)Δt−μ(t)Δt),
wherein L(t) denotes the instantaneous number of pending tasks in the queue at time t as derived from telemetry received by the data acquisition unit, L(t+Δt) represents the forecasted queue length at a future prediction interval t+Δt, constrained by a non-negativity condition through the max(0, . . . ) operator, λ(t) denotes the perturbed task arrival rate at time t computed through a Markov-modulated Poisson process in which each hidden state corresponds to a distinct workload intensity level, μ(t) denotes the predicted service rate at time t computed as the inverse of the expected service duration determined by the learned service-time model, and Δt represents an adaptive time increment that is dynamically varied as an inverse function of the observed variance in recent task inter-arrival intervals to stabilize the predictive simulation resolution.

7. The method of claim 1, wherein the determining of the expected processing duration for each task comprises executing a resource-performance correlation computation that constructs, for each task type, a multidimensional dependency matrix representing the non-linear relation between execution duration, resource allocation ratio, and observed contention indices, wherein the matrix is updated incrementally after each completed task using stochastic gradient descent on the prediction residual, and wherein the service time for a new task is predicted by performing a weighted interpolation within the matrix along the axes corresponding to active CPU core allocation, memory bandwidth utilization, and I/O throughput saturation.

8. The method of claim 1, wherein the computing of the total projected operational cost further comprises constructing a composite cost vector C=[Cᵣ, Cₑ, C_d] representing resource allocation cost, energy consumption cost, and delay penalty cost, respectively, and wherein each component is computed through independent iterative subroutines: the resource allocation cost Cᵣ being obtained by integrating over forecasted infrastructure price functions P(t) retrieved from a pricing data feed; the energy cost Cₑ being computed from instantaneous power draw telemetry multiplied by an adaptive energy pricing coefficient updated hourly; and the delay penalty C_d being computed as the integral over the prediction horizon of the queueing delay weighted by a piecewise polynomial penalty function derived from service-level objectives, wherein the aggregate cost is determined by performing a weighted L2-norm combination of said components to reflect their relative economic significance under current operational constraints.

9. The method of claim 1, wherein the evaluating of the plurality of scaling options comprises executing a parallelized cost-to-action evaluation process wherein each scaling option is simulated as a distinct computational branch, each branch invoking the predictive queueing and cost modeling routines independently with modified input resource configurations, storing intermediate simulation results in shared memory arrays, and applying a policy update iteration in which the expected cost reduction ΔC for each scaling trajectory is calculated, ranked, and passed through a softmax selection function to probabilistically favor lower-cost options while maintaining exploration across multiple scaling paths.

10. The method of claim 1, wherein the selecting of the optimal scaling action further comprises implementing a two-stage decision process in which a primary selector computes a baseline scaling index corresponding to the minimum projected operational cost and a secondary stabilizer applies a hysteresis constraint computed as a function of the recent variance in queue length and task latency metrics, wherein scaling actions are suppressed if the expected cost improvement of the new configuration relative to the current configuration is smaller than a predetermined hysteresis threshold.

11. The method of claim 1, wherein the executing of the selected scaling action through the scaling actuation interface further comprises serializing the scaling instruction sequence into a communication packet conforming to a secure orchestration protocol, performing digital signing of the packet using a cryptographic signature derived from a system key, initiating transmission over a low-latency control channel, awaiting acknowledgment from the orchestration endpoint within a bounded timeout period, and verifying successful execution by cross-referencing the newly instantiated resource identifiers against a resource inventory table maintained in memory, wherein unsuccessful or delayed acknowledgments trigger a rollback subroutine that reverts the scaling decision to the last verified stable configuration.

12. The method of claim 1, wherein the evaluating of potential scaling trajectories for each simulated state over the prediction horizon further comprises executing a Monte Carlo ensemble simulation in which multiple stochastic realizations of workload evolution are generated, each realization being initialized with a random perturbation of the observed arrival and service rate parameters within empirically determined confidence bounds, computing the expected cumulative cost for each trajectory, and determining the optimal scaling trajectory by selecting the one with the minimum mean and lowest standard deviation of cumulative operational cost across all realizations.

13. The method of claim 1, wherein the determining of the confidence level associated with each predicted queueing delay comprises computing the variance of prediction residuals over a sliding history window, estimating uncertainty using an exponentially weighted moving variance estimator, and mapping said uncertainty to a confidence score through an inverse sigmoid transformation, wherein the aggressiveness of the scaling action is adjusted proportionally by modulating the scaling decision step size according to the confidence score.

14. The method of claim 1, wherein the executing of predictive and cost evaluation computations is optimized through a pipelined execution structure implemented over multi-core computational threads, wherein distinct computational phases including telemetry normalization, queue prediction, cost evaluation, and decision computation are executed in overlapped stages with inter-thread data transfer through shared cache memory segments, and wherein synchronization barriers are inserted after each prediction cycle to ensure consistency of shared data structures before proceeding to actuation, and wherein the step of predicting the future queueing state further comprises dynamically adjusting the simulation granularity based on the variance of recent task arrival intervals, such that when high burstiness is detected, the prediction step size Δt is reduced according to an inverse proportional relationship Δt=k/(1+σₐ), where σₐ represents the standard deviation of arrival intervals and k is a calibration constant, and wherein during low-variance intervals, Δt is adaptively enlarged to conserve computational resources without degrading predictive accuracy.

15. The method of claim 1, wherein the determining of expected processing duration further comprises a feedback correction mechanism that compares the predicted duration for each task with the actual completion time upon task termination, computes a residual error vector for each workload type, and applies an incremental model weight update using an online least mean squares (LMS) correction rule of the form w(t+1)=w(t)+η·e(t)×(t), where η is a learning rate parameter, e(t) the prediction error, and x(t) the corresponding workload feature vector.

16. The method of claim 1, wherein the computing of total projected operational cost comprises periodically validating the accuracy of cost estimation models by comparing predicted versus actual cost realizations after scaling events, computing an error margin distribution over a recent observation window, and applying statistical bias correction to each cost component by recalibrating cost coefficients according to the median bias ratio.

17. The method of claim 1, wherein the evaluating of scaling options includes a temporal coherence constraint that restricts scaling transitions to occur only when at least M consecutive prediction cycles indicate the same optimal scaling direction, where M is dynamically computed as a function of the average queue length volatility index, and wherein the predicting of the future queueing state and computing of expected processing duration are executed within a shared computational workspace maintained in volatile memory, wherein intermediate variables including arrival rate estimates, predicted queue length vectors, and task service matrices are stored in double-buffered memory segments, alternating between read and write access at successive prediction cycles to prevent concurrent memory contention and to guarantee atomic consistency during multi-threaded predictive computation.

18. The method of claim 1, wherein the selecting of the optimal scaling action comprises computing a sensitivity index representing the gradient of projected operational cost with respect to incremental resource additions or removals, wherein the scaling direction is chosen according to the sign of the sensitivity index, and the magnitude of the scaling adjustment is determined through numerical optimization using a bounded gradient descent iteration with an adaptive learning coefficient, and wherein the computing of the delay penalty cost comprises constructing a cumulative distribution function of predicted task waiting times, computing quantile boundaries corresponding to service-level objective percentiles, and integrating the penalty over only the tail region of the distribution exceeding the predefined latency threshold, such that penalty computation emphasizes outlier delays while preserving computational efficiency by ignoring compliant portions of the workload distribution.

19. The method of claim 1, wherein the evaluating of potential scaling trajectories further comprises computing a trajectory stability score for each candidate configuration by analyzing the variance of predicted queue length under simulated perturbations of arrival rate and service rate parameters, wherein configurations exhibiting variance above a stability tolerance threshold are discarded prior to cost comparison, and wherein the executing of the selected scaling action includes initiating a dual-phase confirmation process in which an initial provisional scaling command is executed in a shadow deployment mode for a test duration shorter than the average queueing cycle, monitoring instantaneous utilization and latency response, and finalizing the scaling only if the observed performance metrics deviate from predicted values by less than a predefined validation tolerance.

20. A system for cost-aware autoscaling of artificial intelligence workloads using the method of claim 1, said system comprising:
a data acquisition unit configured to receive and process a plurality of workload parameters including task arrival rate, service time statistics, resource utilization metrics, and queue length values from a plurality of distributed computational nodes executing artificial intelligence workloads;
a predictive queueing unit communicatively coupled to the data acquisition unit, the predictive queueing unit configured to determine, in real time, future queueing states of the workloads by modeling arrival patterns through a stochastic queueing process and by determining an estimated service time for each task based on historical execution data and current resource states;
a cost estimation unit configured to compute a total projected operational cost associated with scaling decisions, the total projected operational cost including a resource allocation cost derived from cloud resource pricing information and a delay cost computed from a service-level objective violation penalty associated with predicted queueing delay;
a scaling decision unit coupled to the predictive queueing unit and the cost estimation unit, the scaling decision unit configured to evaluate a plurality of scaling options including scale-up, scale-down, and steady-state maintenance by comparing the total projected operational cost of each option and selecting an optimal scaling action that minimizes cost while maintaining latency and throughput constraints; and
a hardware-integrated autoscaling controller device comprising a predictive computation processor, a cost-decision processor, and a scaling actuation interface, wherein the autoscaling controller device executes the selected scaling action by controlling the instantiation or termination of computing resources in a distributed computing infrastructure.
